(19) United States
(12) Patent Application Publication
(10) Pub. No.: US 2014/0026988 A1
(43) Pub. Date: Jan. 30, 2014

(54) ACTIVE HYDRAULIC FLUID LEVEL CONTROL FOR AN AUTOMATIC TRANSMISSION

(71) Applicants: Paul R. Peterson, Orchard Lake, MI (US); Jason Mallory, Livonia, MI (US); Todd R. Berger, Pinckney, MI (US); Wayne B. Vogel, Canton, MI (US)

(72) Inventors: Paul R. Peterson, Orchard Lake, MI (US); Jason Mallory, Livonia, MI (US); Todd R. Berger, Pinckney, MI (US); Wayne B. Vogel, Canton, MI (US)

(73) Assignee: GM GLOBAL TECHNOLOGY OPERATIONS LLC, DETROIT, MI (US)

(21) Appl. No.: 13/560,616

(22) Filed: Jul. 27, 2012

(51) Int. Cl. F03B 11/00

(52) U.S. Cl. 137/544

(57) ABSTRACT

A hydraulic control system for a transmission includes a sump tank, a front cover, a wall, and a flow control valve. The sump tank is attached to a bottom end of the transmission. The front cover includes an overflow tube and a hydraulic fluid input. The wall hydraulically separates the sump tank and the front cover. The flow control valve is disposed in the wall between the sump tank and front cover. The flow control valve is open when the transmission is going through an extreme maneuver and requires a greater amount of hydraulic fluid in the sump tank and the flow control valve is closed during normal transmission operation.

### TECHNICAL FIELD

The invention relates to a control system for an automatic transmission, and more particularly to a control system for actively maintaining hydraulic fluid level in the sump tank of an automatic transmission.

### BACKGROUND

A typical automatic transmission includes a hydraulic control system that is employed to provide cooling and lubrication to components within the transmission and to actuate a plurality of torque transmitting devices. The hydraulic control system typically includes a sump that collects hydraulic fluid from the remainder of the hydraulic control system, gathers it to a pool of hydraulic fluid to be suctioned back into the hydraulic control system. A minimum level of hydraulic fluid is required in the sump in order to feed the hydraulic control system for all ranges of transmission operation and dynamic movement of the hydraulic fluid in the sump. Due to the minimum amount of hydraulic fluid requirements, the level of the hydraulic fluid in the sump interferes with the rotating components of the transmission. The rotating components, including gears, clutch plates, and interconnecting members; traveling through the pool of hydraulic fluid experience a great increase in drag and in turn decreases the efficiency of the transmission.

While previous hydraulic control systems are useful for their intended purpose, the need for new and improved hydraulic control system configurations within transmissions which exhibit improved performance, especially from the standpoints of efficiency, responsiveness and smoothness, is essentially constant. Accordingly, there is a need for an improved, cost-effective hydraulic control system for use in a hydraulically actuated automatic transmission.

### SUMMARY

A transmission having a hydraulic fluid control system is provided. The control system includes a sump tank, a front cover, a separation wall, and a flow control valve. The sump tank is attached to a bottom end of the transmission and includes a pick-up tube and filter. The front cover is attached to the transmission and includes an overflow tube and a hydraulic fluid input. The overflow tube has a first end in fluid communication with the sump tank and a second end in fluid communication with the front cover. The wall hydraulically separates the sump tank and the front cover and wherein the first end of the overflow tube is disposed in the wall. The flow control valve is disposed in the wall between the sump tank and front cover. The flow control valve is in communication with each of the sump tank and the front cover. The flow control valve is open when the transmission is going through an extreme maneuver and requires a greater amount of hydraulic fluid in the sump tank and the flow control valve is closed during normal transmission operation.

In one example of the present invention, the second end of the overflow tube is at a distance H above a bottom of the front cover.

In another example of the present invention, the hydraulic fluid input of the front cover collects hydraulic fluid from the transmission and directs the hydraulic fluid into the front cover.

In yet another example of the present invention, the overflow tube has a 90° bend between the first end and the second end.

In yet another example of the present invention, the control valve is disposed in the wall at a distance L from a bottom of the front cover.

In yet another example of the present invention, the extreme maneuver includes one of a hard deceleration, a hard acceleration, a sharp turn, a steep ascent, and a steep descent.

Further features and advantages of the present invention will become apparent by reference to the following description and appended drawings wherein like reference numbers refer to the same component, element or feature.

### BRIEF DESCRIPTION OF THE DRAWINGS

The drawings described herein are for illustration purposes only and are not intended to limit the scope of the present disclosure in any way.

FIG. 1 is a schematic of portion of a hydraulic control system for an automatic transmission according to the principles of the present invention;

FIG. 2 is a diagram of another embodiment of a schematic of portion of a hydraulic control system for an automatic transmission according to the principles of the present invention;

FIG. 3 is a diagram of another embodiment of a schematic of portion of a hydraulic control system for an automatic transmission according to the principles of the present invention; and

FIG. 4 is a diagram of another embodiment of a schematic of portion of a hydraulic control system for an automatic transmission according to the principles of the present invention.

### DESCRIPTION

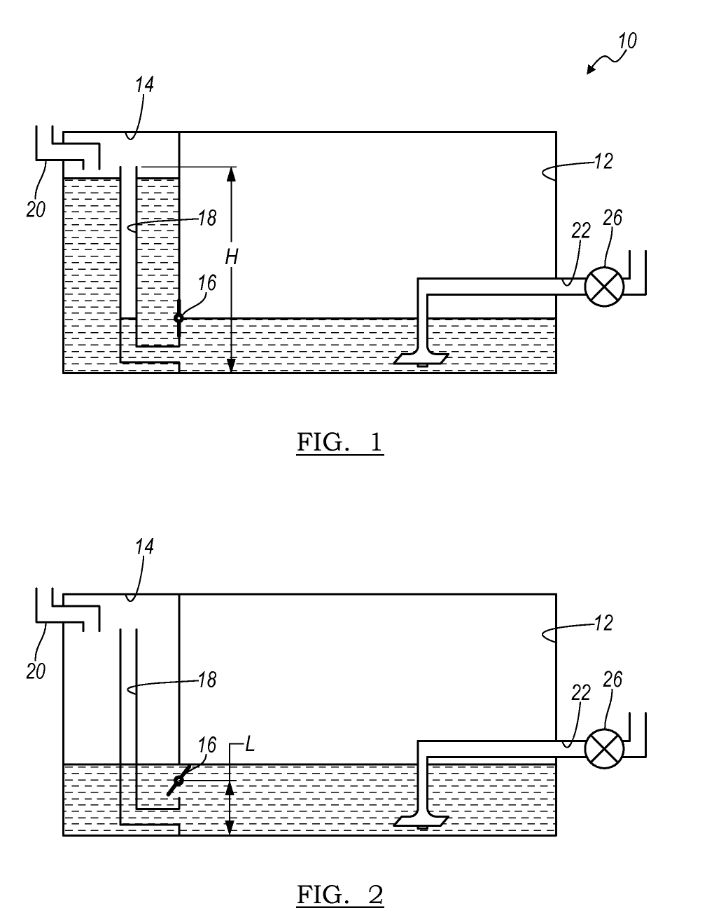

With reference to FIG. 1, a portion of a hydraulic control system according to the principles of the present invention is generally indicated by reference number 10. The portion of the hydraulic control system 10 includes a sump 12, a valve body cover or front cover 14, a separation wall 15, a control valve 16, an overflow tube 18, a fluid input passage 20, and a fluid pick-up tube and filter 22. The hydraulic control system 10 may also include various other subsystems or modules, such as a lubrication subsystem, a torque converter clutch subsystem, and/or a cooling subsystem, without departing from the scope of the present invention.

The portion of the hydraulic control system 10 is operable to collect hydraulic fluid 24 from various sources in the transmission and provide a source of hydraulic fluid 24 for the rest of the hydraulic control system. More particularly, the front cover 14 is filled with hydraulic fluid 24 by a fluid input passage 20 which collects hydraulic fluid 24 from hydraulic control system leakage such as from spool valves, pressure control solenoids, excess control valve exhaust, etc. The sump 12 is a tank or reservoir preferably disposed at the bottom of a transmission housing and proximate the front cover 14. The wall 15 hydraulically separates the front cover 14 and the sump 12. The control valve 16 is placed in the wall at a distance L from the bottom of the front cover allowing the front cover 14 to selectively communicate with the sump 12. The control valve 16 is solenoid operated and selectively controlled to allow hydraulic fluid 24 to flow from the front cover 14 to the sump 12 under certain operating conditions. The overflow tube 18 has a first and a second end 18A, 18B with a 90° bend 18C in between the two ends 18A, 18B. The first end 18A of the overflow tube 18 is placed in the wall 15 so that the interior of the overflow tube 18 communicates with the sump 12. The second end 18B of the overflow tube 18 extends to a height H above the bottom of the front cover 14. The overflow tube 18 also allows hydraulic fluid 24 to flow from the front cover 14 to the sump 12, however, only when the level of hydraulic fluid 24 in the front cover 14 reaches a certain height H determined by the height H of the overflow tube 18. When the hydraulic fluid 24 in the front cover 14 reaches the height H, the hydraulic fluid 24 flows into the second end 18B of the overflow tube 18 and into the sump 12. The hydraulic fluid 24 is forced from the sump 12 and communicated throughout the remainder of the hydraulic control system via a pump 26 and the fluid pick-up tube and filter 22. The pump 26 is preferably driven by an engine (not shown) and may be, for example, a gear pump, a vane pump, a gerotor pump, or any other positive displacement pump.

The hydraulic control system 10 as shown in FIG. 1 displays the state of the control system 10 while the control valve 16 is closed. The level of the hydraulic fluid 24 in the front cover can reach as high as the top of the overflow tube 18. As additional hydraulic fluid 24 is transferred to the front cover 14 the hydraulic fluid rises above the opening of the overflow tube 18, flows down the overflow tube 18, and into the sump 12 thus raising the level of hydraulic fluid 24 in the sump 12. Keeping the control valve 16 closed and the level of hydraulic fluid 24 in the sump 12 low enables the planetary gear sets, shafts or members, and clutches (not shown) of the transmission to rotate freely without passing through a pool of hydraulic fluid 24 in the sump 12. The result is a more efficient transmission requiring less torque input to get the same torque output and improved fuel economy. Referring now to FIG. 2, the control system 10 is depicted with the control valve 16 open. In this state, the level of hydraulic fluid 24 in both the front cover 14 and the sump 12 remains equal. Upon adding additional hydraulic fluid 24 to the front cover 14 the level of hydraulic fluid 24 in the sump raises an equal amount.

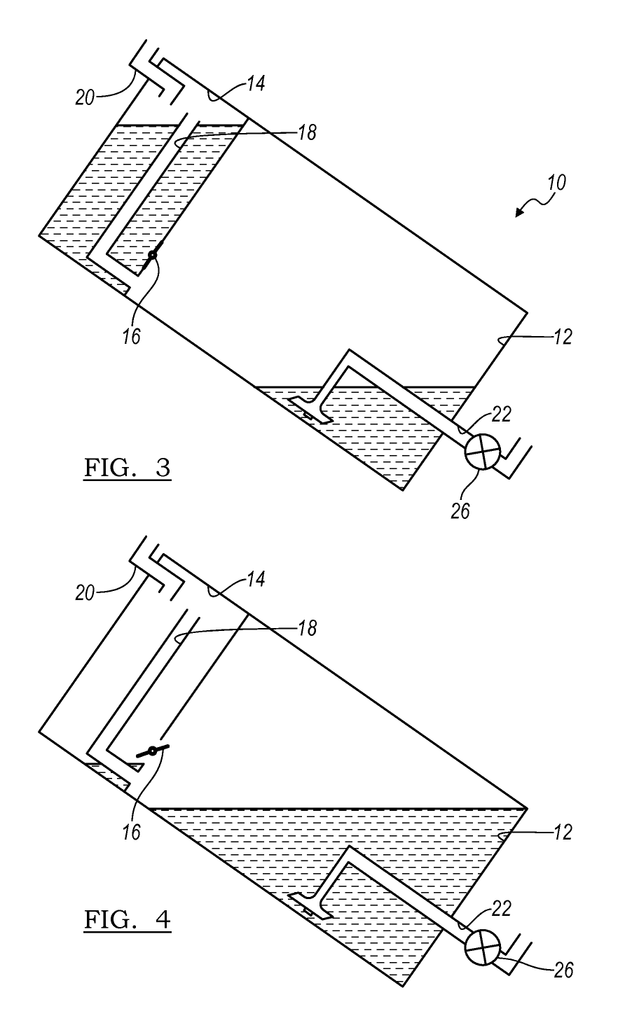

Referring now to FIGS. 3 and 4, the hydraulic control system 10 is illustrated showing a simulated maneuver, for example, a hard acceleration or braking event, a sharp lateral turn, or an aggressive hill ascent or descent. In FIG. 3, front cover 14 is full of hydraulic fluid 24, the control valve 16 is closed, and the sump 12 is running low on hydraulic fluid 24 to feed the fluid pick-up tube and filter 22. Alternatively, in FIG. 4, the control valve 16 is open and hydraulic fluid 24 from the front cover 14 has flowed into the sump 12 thus providing plenty of hydraulic fluid 24 to the fluid pick-up tube and filter 22. Once the extreme maneuver is completed, the control valve 16 is closed and the front cover 14 fills with hydraulic fluid 24 and the hydraulic fluid 24 level in the sump 12 returns to the high efficiency level.

The description of the invention is merely exemplary in nature and variations that do not depart from the general essence of the invention are intended to be within the scope of the invention. Such variations are not to be regarded as a departure from the spirit and scope of the invention.

What we claim is:

1. A transmission having a hydraulic fluid control system, the control system including:
a sump tank attached to a bottom end of the transmission, the sump tank including a pick-up tube and filter;
a front cover attached to the transmission, the front cover including an overflow tube and a hydraulic fluid input, and wherein the overflow tube has a first end in fluid communication with the sump tank and a second end in fluid communication with the front cover;
a wall hydraulically separating the sump tank and the front cover and wherein the first end of the overflow tube is disposed in the wall, and
a flow control valve disposed in the wall between the sump tank and front cover, and wherein the flow control valve is in communication with each of the sump tank and the front cover; and
wherein the flow control valve is open when the transmission is going through an extreme maneuver and requires a greater amount of hydraulic fluid in the sump tank and the flow control valve is closed during normal transmission operation.

2. The transmission of claim 1 wherein the second end of the overflow tube is at a distance H above a bottom of the front cover.

3. The transmission of claim 1 wherein the hydraulic fluid input of the front cover collects hydraulic fluid from the transmission and directs the hydraulic fluid into the front cover.

4. The transmission of claim 1 wherein the overflow tube has a 90° bend between the first end and the second end.

5. The transmission of claim 1 wherein the control valve is disposed in the wall at a distance L from a bottom of the front cover.

6. The transmission of claim 1 wherein the extreme maneuver includes one of a hard deceleration, a hard acceleration, a sharp turn, a steep ascent, and a steep descent.

7. The transmission of claim 1 wherein the pick-up tube and filter are in hydraulic communication with a hydraulic fluid pump.

8. A transmission having a hydraulic fluid control system, the control system including:
a sump tank attached to a bottom end of the transmission, the sump tank including a pick-up tube and filter;
a front cover attached to the transmission, the front cover including an overflow tube and a hydraulic fluid input, and wherein the overflow tube has a first end in fluid communication with the sump tank and a second end in fluid communication with the front cover;
a wall hydraulically separating the sump tank and the front cover, and
a flow control valve disposed in the wall between the sump tank and front cover, and wherein the flow control valve is in communication with each of the sump tank and the front cover; and
wherein the flow control valve is open when the transmission is going through an extreme maneuver and requires a greater amount of hydraulic fluid in the sump tank and the flow control valve is closed during normal transmission operation.

9. The transmission of claim 8 wherein the second end of the overflow tube is at a distance H above a bottom of the front cover.

10. The transmission of claim 8 wherein the hydraulic fluid input of the front cover collects hydraulic fluid from the transmission and directs the hydraulic fluid into the front cover.

11. The transmission of claim 8 wherein the overflow tube has a 90° bend between the first end and the second end.

12. The transmission of claim 8 wherein the first end of the overflow tube is disposed in the wall.

13. The transmission of claim 8 wherein the control valve is disposed in the wall at a distance L from a bottom of the front cover.

14. The transmission of claim 8 wherein the extreme maneuver includes one of a hard deceleration, a hard acceleration, a sharp turn, a steep ascent, and a steep descent.

15. The transmission of claim 8 wherein the pick-up tube and filter are in hydraulic communication with a hydraulic fluid pump.

16. A transmission having a hydraulic fluid control system, the control system including:
a sump tank attached to a bottom end of the transmission, the sump tank including a pick-up tube and filter;
a front cover attached to the transmission, the front cover including an overflow tube and a hydraulic fluid input, and wherein the overflow tube has a first end in fluid communication with the sump tank and a second end in fluid communication with the front cover at a distance H above a bottom of the front cover;
a wall hydraulically separating the sump tank and the front cover, and
a flow control valve disposed in the wall between the sump tank and front cover at a distance L from a bottom of the front cover, and wherein the flow control valve is in communication with each of the sump tank and the front cover; and
wherein the flow control valve is open when the transmission is going through an extreme maneuver and requires a greater amount of hydraulic fluid in the sump tank and the flow control valve is closed during normal transmission operation.

17. The transmission of claim 16 wherein the hydraulic fluid input of the front cover collects hydraulic fluid from the transmission and directs the hydraulic fluid into the front cover.

18. The transmission of claim 16 wherein the overflow tube has a 90° bend between the first end and the second end.

19. The transmission of claim 16 wherein the first end of the overflow tube is disposed in the wall.

20. The transmission of claim 16 wherein the extreme maneuver includes one of a hard deceleration, a hard acceleration, a sharp turn, a steep ascent, and a steep descent.
